(19) United States
(12) Patent Application Publication
(10) Pub. No.: US 2022/0051387 A1
(43) Pub. Date: Feb. 17, 2022

(54) IMAGE PROCESSING METHOD, IMAGE PROCESSING APPARATUS, AND PROGRAM

(71) Applicant: NEC Corporation, Minato-ku, Tokyo (JP)

(72) Inventor: Hiroyuki KOBAYASHI, Tokyo (JP)

(73) Assignee: NEC Corporation, Minato-ku, Tokyo (JP)

(21) Appl. No.: 17/435,764

(22) PCT Filed: Feb. 17, 2020
(86) PCT No.: PCT/JP2020/005997

§ 371 Date: Sep. 2, 2021

(30) Foreign Application Priority Data
Mar. 8, 2019 (JP) 2019-042432

(51) Int. Cl. G06T 7/00; G06T 7/70

(52) U.S. Cl. CPC G06T 7/0002; G06T 7/70; G06T 2207/20084; G06T 2207/20081; G06T 2207/20224

(57) ABSTRACT

An image processing apparatus includes an abnormal image generator that generates an abnormal image by inserting abnormal data into a learning normal image based on priorities set for each abnormal data, a priority setting unit that inputs the abnormal image to a model that has learned to eliminate the abnormal data from the abnormal image and newly sets the priority of the abnormal data inserted into the learning normal image based on the difference between an output image outputted from the model and the learning normal image, and a learning unit that learns the model so that the difference between the output image and leaning normal image is reduced.

### TECHNICAL FIELD

The present invention relates to an image processing method, image processing apparatus, and program.

### BACKGROUND ART

In recent years, there has been used an industrial product inspection method including capturing images of inspection objects and automatically determining whether the inspection objects are normal or abnormal, based on the captured images. Such a determination requires previously generating a neural-network model by learning images of normal products and/or abnormal products. By inputting the captured images of the inspection objects to the generated model, the inspection objects are determined to be normal or abnormal.

Among methods for generating a neural-network model used in the product inspection method described above is a method disclosed in Patent Document 1. Patent Document 1 generates a pseudo image by combing an image of a normal product to be leant, with abnormal data representing characteristics of an abnormal product. In Patent Document 1, a random number value is used to determine how to combine the normal product image with the abnormal data, and the difference between the normal product image and an image of the abnormal product is used as the abnormal data.
Patent Document 1: Japanese Unexamined Patent Application Publication No. 2005-156334

### SUMMARY

However, the above method may fail to sufficiently learn abnormal data. For example, the above method may have difficulty in sufficiently learning abnormal data in a portion having a complicated pattern of the normal product image, or in a product area, such as an edge. Also, depending on the shape of abnormal data, the above method may have difficulty in sufficiently learning the shape of the abnormal data in any area. A failure to sufficiently learn abnormal data results in a reduction in the abnormal product detection accuracy.

Accordingly, an object of the present invention is to resolve the above problems, that is, the failure to sufficiently learn the image including the abnormal data and thus the reduction in the abnormal product detection accuracy.

An image processing method according to an aspect of the present invention includes generating an abnormal image by inserting abnormal data into a learning normal image based on priorities set for each abnormal data, inputting the abnormal image to a model that has learned to eliminate the abnormal data from the abnormal image and newly setting the priority of the abnormal data inserted into the learning normal image based on a difference between an output image outputted from the model and the learning normal image, and learning the model so that the difference between the output image and the learning normal image is reduced.

An image processing apparatus according to another aspect of the present invention includes an abnormal image generator configured to generate an abnormal image by inserting abnormal data into a learning normal image based on priorities set for each abnormal data, a priority setting unit configured to input the abnormal image to a model that has learned to eliminate the abnormal data from the abnormal image and to newly set the priority of the abnormal data inserted into the learning normal image based on a difference between an output image outputted from the model and the learning normal image, and a learning unit configured to learn the model so that the difference between the output image and the learning normal image is reduced.

A program according to yet another aspect of the present invention is a program for implementing, in an information processing apparatus:

an abnormal image generator configured to generate an abnormal image by inserting abnormal data into a learning normal image based on priorities set for each abnormal data;

a priority setting unit configured to input the abnormal image to a model that has learned to eliminate the abnormal data from the abnormal image and to newly set the priority of the abnormal data inserted into the learning normal image based on a difference between an output image outputted from the model and the learning normal image; and

a learning unit configured to learn the model so that the difference between the output image and the learning normal image is reduced.

The present invention thus configured is able to improve the abnormal product detection accuracy.

### BRIEF DESCRIPTION OF DRAWINGS

FIG. 1 is a block diagram showing the configuration of an image inspection apparatus according to a first example embodiment of the present invention;

FIG. 2 is a diagram showing an example of priority data stored in a priority data storage unit disclosed in FIG. 1;

FIG. 3 is a diagram showing the aspect of a process performed by the image inspection apparatus disclosed in FIG. 1;

FIG. 4 is a diagram showing the aspect of a process performed by the image inspection apparatus disclosed in FIG. 1;

FIG. 5 is a flowchart showing an operation of the image inspection apparatus disclosed in FIG. 1;

FIG. 6 is a flowchart showing an operation of the image inspection apparatus disclosed in FIG. 1;

FIG. 7 is a flowchart showing an operation of the image inspection apparatus disclosed in FIG. 1;

FIG. 8 is a block diagram showing the hardware configuration of an image processing apparatus according to a second example embodiment of the present invention;

FIG. 9 is a block diagram showing the configuration of the image processing apparatus according to the second example embodiment of the present invention; and

FIG. 10 is a flowchart showing an operation of the image processing apparatus according to the second example embodiment of the present invention.

### EXAMPLE EMBODIMENTS

### First Example Embodiment

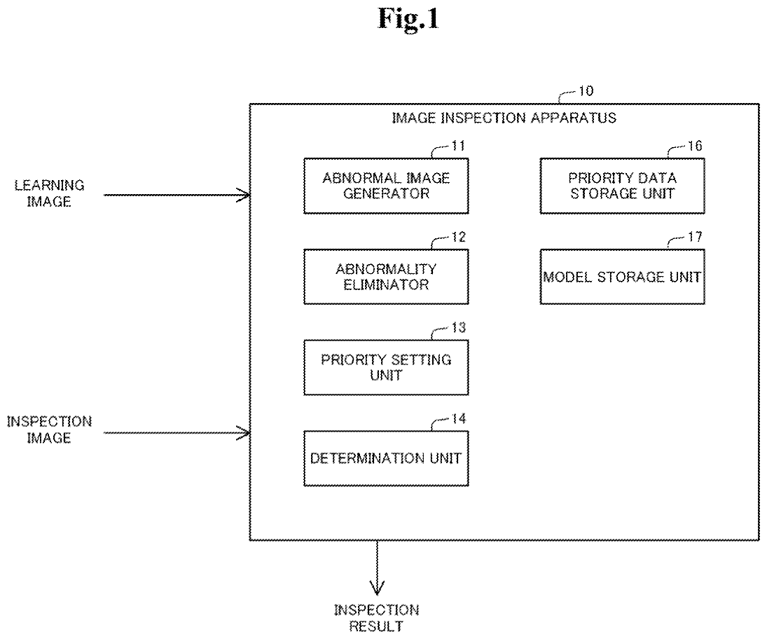

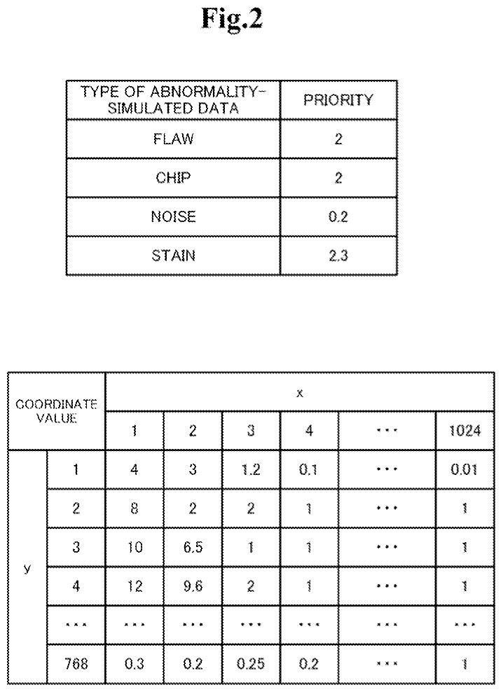

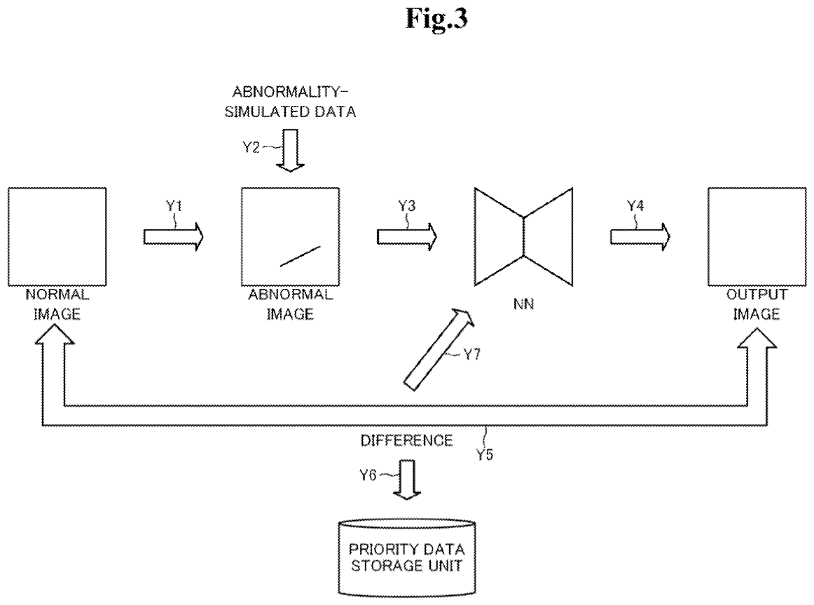

A first example embodiment of the present invention will be described with reference to FIGS. 1 to 7. FIGS. 1 and 2 are diagrams showing the configuration of an image inspection apparatus, and FIGS. 3 to 7 are diagrams showing operations of the image inspection apparatus.

### [Configuration]

An image inspection apparatus 10 (image processing apparatus) according to the present invention inspects an inspection object, such as an industrial product, by determining whether the inspection object is normal or abnormal using a captured image of the inspection object. In particular, as will be described below, the image inspection apparatus 10 first learns a model using a learning image and then inspects an inspection image using the learned model.

The image inspection apparatus 10 includes one or more information processing apparatuses each including an arithmetic logic unit and a storage unit. As shown in FIG. 1, the image inspection apparatus 10 includes an abnormal image generator 11, an abnormality eliminator 12, a priority setting unit 13, and a determination unit 14. These elements are implemented when the arithmetic logic unit executes programs. The storage unit(s) of the image inspection apparatus 10 includes a priority data storage unit 16 and a model storage unit 17. The respective elements will be described in detail below.

The abnormal image generator 11 generates an abnormal image by inserting abnormality-simulated data (abnormal data) into a normal image (learning normal image), which is a learning image previously prepared for learning. For example, the following types of data are used as abnormality-simulated data.

### “Flaw”

A linear “flaw” is inserted into the image. For example, the insertion method includes:

1. determining a color (using the color of a part of the image or a predetermined color);
2. determining the end points of a line (determining two points on the image randomly); and
3. inserting a straight line (adding a straight line between the determined end points using the determined color).

### “Chip”

A planar “chip” is inserted into the image. For example, the insertion method includes:

1. determining a color (using the color of a part of the image or a predetermined color);
2. determining the type of a chip (determining the type of a polygon randomly);
3. determining the vertexes of the chip (determining the vertexes of the polygon on the image randomly); and
4. inserting the chip (adding the polygon formed by connecting the determined vertexes using lines of the determined color)

### “Noise”

Noise is inserted into the image. For example, white noise is inserted into the entire image.

### “Stain”

A planar stain is inserted into the image. For example, the insertion method includes:

1. determining a color (using the color of a part of the image or a predetermined color);
2. determining the shape and area of a stain (determining the range using a circle or polygon; may distribute light and shade based on normal distribution or the like); and
3. inserting the stain (adding the stain having the determined shape using the determined color).

The abnormal image generator 11 then determines the type of abnormality-simulated data to be inserted into the normal image, or the position on the normal image into which abnormality-simulated data is to be inserted, based on priorities (type priorities, position priorities) stored in the priority data storage unit 16. FIG. 2 shows an example of the priorities stored in the priority data storage unit 16. An upper diagram of FIG. 2 shows type priorities set for each type of abnormality-simulated data, and a lower diagram of FIG. 2 shows position priorities set for each position on the normal image, that is, set for respective coordinates (each pixel) on the normal image. While the abnormal image generator 11 uses a random number to determine the type or position of abnormality-simulated data to be inserted, it determines the type or position such that abnormality-simulated data of a type having a higher type priority is inserted with a higher probability than other types and abnormality-simulated data is inserted into a position having a higher position priority with a higher probability than other positions. That is, abnormality-simulated data of a type having a higher type priority value is inserted more preferentially than other types, and abnormality-simulated data is inserted more preferentially into a position having a higher position priority value than other positions.

An example of an abnormality-simulated data insertion process performed by the abnormal image generator 11 will be described. First, the abnormal image generator 11 determines the type of abnormality-simulated data to be inserted, using a random number on the basis of the type priorities. At this time, assuming that the sum of the type priority values is A and the type priority value of particular abnormality-simulated data is B, the abnormal image generator 11 calculates B/A as the probability that the particular abnormality-simulated data will be selected. Thus, the particular abnormality-simulated data is selected with the probability of B/A. Accordingly, data of a type having a higher type priority value is inserted more preferentially. For example, in the case of the type priority values shown in the upper diagram of FIG. 2, the probability that abnormality-simulated data “chip” will be selected is 2/7.5.

The abnormal image generator 11 then determines the position on the normal image in which abnormality-simulated data will be inserted, using a random number on the basis of the position priorities. At this time, assuming that the sum of position priority values is A and the position priority of particular coordinate values on the normal image is B, the abnormal image generator 11 calculates B/A as the probability that the particular coordinate values will be selected as coordinate values on the normal image into which the particular abnormality-simulated data will be inserted. Thus, the particular coordinate values are selected as coordinate values on the normal image into which the particular abnormality-simulated data will be inserted, with the probability of B/A. Accordingly, the abnormality-simulated data is inserted more preferentially into coordinate values having a higher position priority value than other coordinate values. For example, the lower diagram of FIG. 2 shows the position priority values of the coordinate values of a 1024×768 pixel image, and abnormality-simulated data is inserted into coordinate values having a higher position priority value with a higher probability.

When the abnormal image generator 11 determines the type and position of abnormality-simulated data to be inserted as described above, it inserts the determined type of abnormality-simulated data into the determined position on the normal image. For example, as shown in FIG. 3, the abnormal image generator 11 generates an abnormal image by inserting a linear “chip” into the normal image. Note that if the type of abnormality-simulated data is “noise,” the determined position is not used. This is because noise is a type of abnormality-simulated data that is inserted into the entire image.

The abnormality eliminator 12 inputs the abnormal image thus generated to a model stored in the model storage unit 17 and outputs an output image processed by this model. Here, the model stored in the model storage unit 17 consists of a neural network NN that has leant to eliminate the abnormality-simulated data from the abnormal image and to output the resulting output image.

The abnormality eliminator 12 (learning unit) then learns the model. Specifically, as shown in FIG. 3, the abnormality eliminator 12 calculates the difference between the previously acquired normal image into which the abnormality-simulated data has yet to be inserted and the image outputted from the model. For example, the abnormality eliminator 12 obtains the pixel-by-pixel difference values between the normal image and the output image and calculates the sum of the absolute values of the difference values as the difference value between the two images. The abnormality eliminator 12 then learns the model, which is the neural network NN, so that the difference between the normal image and output image is reduced. Thus, the model is learned so that the difference between the normal image and output image is further reduced, that is, so that the abnormality-simulated data is further eliminated from the abnormal image. For example, the abnormality eliminator 12 uses an input reproduction technique, such as an auto-encoder in deep learning. The abnormality eliminator 12 then passes, to the priority setting unit 13, the difference value between the output image from the model and the normal image calculated in the above learning.

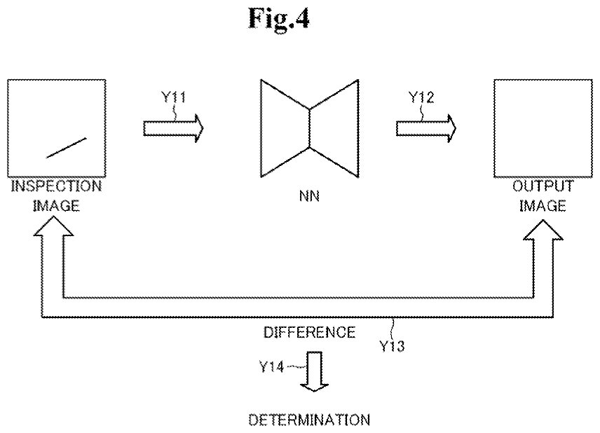

Also, as shown in FIG. 4, during inspection of a product, the abnormality eliminator 12 inputs a captured inspection image of the product to the model consisting of the learned neural network NN and the model eliminates an abnormal portion actually generated on the product from the inspection image and outputs the resulting output image. The abnormality eliminator 12 then calculates the difference between the inspection image and the output image and passes the difference to the determination unit 14.

The priority setting unit 13 receives, from the abnormality eliminator 12, the difference value between the output image from the model and the normal image and newly sets the type priority of the abnormality-simulated data inserted into the normal image, based on the difference value. In particular, the priority setting unit 13 calculates a new type priority such that the value of the type priority of the abnormality-simulated data inserted to the normal image is larger as the difference value between the normal image and the output image is larger. That is, when the difference value is larger, the abnormality-simulated data is considered as less properly learned data and therefore the priority setting unit 13 performs a process of increasing the priority of such abnormality-simulated data. As an example, the priority setting unit 13 sets a priority factor having a larger value as the difference value is larger, as described below, and calculates a new priority by multiplying the current type priority by the priority factor. If the relationship between the difference value and a preset threshold M or N (M<N) is as follows, the priority factor is obtained as follows:

if difference value<M, priority factor is “1/α” (α>1);
if M≤difference value<N, priority factor is “1”; and
if N<difference value, priority factor is “α” (α>1).

The priority setting unit 13 then stores the newly calculated type priority of the type of abnormality-simulated data in the priority data storage unit 16 and thus updates the type priority shown in FIG. 2. Thus, during subsequent learning, the type of abnormality-simulated data to be inserted to the normal image is determined based on the updated type priority.

Similarly, the priority setting unit 13 newly sets the position priority of the position, that is, the coordinates on the normal image into which the abnormality-simulated data has been inserted, based on the difference value between the output image from the model and the normal image calculated in the learning. In particular, the abnormality eliminator 12 calculates a new position priority such that the position priority value of the coordinates on the normal image into which the abnormality-simulated data has been inserted is larger as the difference value between the normal image and the output image is larger. That is, when the difference value is large, the insertion position is considered as a position that has not been learned properly and therefore the priority setting unit 13 performs a process of increasing the position priority of the coordinates, which are such a position. As an example, the priority setting unit 13 sets a priority factor having a larger value as the difference value is larger and calculates a new priority by multiplying the current position priority by the priority factor.

The priority setting unit 13 then stores the newly calculated position priority of the coordinates on the normal image in the priority data storage unit 16 and thus updates the position priority shown in the lower diagram of FIG. 2. Thus, the position, that is, the coordinates on the normal image into which abnormality-simulated data is to be inserted at the time of subsequent learning is determined based on the updated position priority. Note that the priority setting unit 13 does not have to update the position priority by newly calculating the position priority of only the coordinates into which the abnormality-simulated data has been inserted as described above. For example, the priority setting unit 13 may calculate new priorities by multiplying the position priorities of the coordinates into which the abnormality-simulated data has been inserted and coordinates located in a range consisting of a predetermined number of pixels around the coordinates by the above priority factor. Also, the priority setting unit 13 may calculate new priorities by setting priority factors having lower values closer to 1 for coordinates further from the coordinates into which the abnormality-simulated data has been inserted and multiplying the position priorities of the coordinates by the priority factors thus set.

The determination unit 14 receives the difference value between the output image from the model and the inspection image calculated by the abnormality eliminator 12 during the inspection and determines whether the inspection image is normal or abnormal, based on the difference value. For example, if the difference value is equal to or greater than a preset determination threshold, the determination unit 14 determines that the inspection image is abnormal; if the difference value is smaller than the threshold, it determines that the inspection image is normal. The determination unit 14 then outputs the determination as an inspection result.

[Operation]

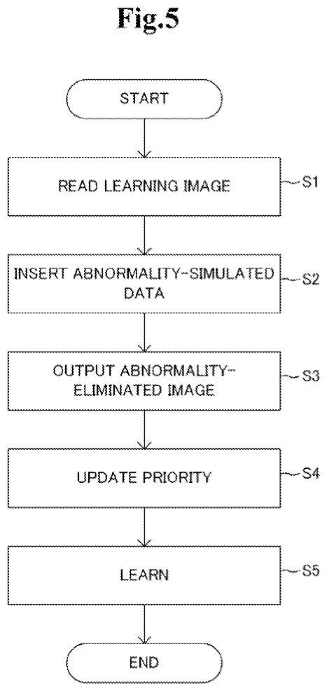

Next, the operations of the image inspection apparatus 10 will be described mainly with reference to FIGS. 3 to 7. First, the operation during learning will be described with reference to the diagram showing the aspect of the process of FIG. 3 and the flowcharts of FIGS. 5 to 7. While the model is repeatedly learned using multiple learning images a number of times, the operation during one-time learning will be described below.

First, the image inspection apparatus 10 reads the normal image, which is a learning image (step S1 of FIG. 5). The image inspection apparatus 10 then generates the abnormal image by inserting the abnormality-simulated data into the normal image (arrows Y1 and Y2 of FIG. 3, step S2 of FIG. 5). A method for inserting the abnormality-simulated data into the normal image will be described in detail later.

The image inspection apparatus 10 then inputs the abnormal image thus generated to the model (arrow Y3 of FIG. 3) and obtains the output image, which is an abnormality-eliminated image (arrow Y4 of FIG. 3, step S3 of FIG. 5). The image inspection apparatus 10 then makes a comparison between the output image and the normal image into which the abnormality-simulated data has yet to be inserted and calculates the difference therebetween (arrow Y5 of FIG. 3). The image inspection apparatus 10 then calculates the priority (type priority, position priority) of the type or insertion position of the abnormality-simulated data as shown in FIG. 2 based on the calculated difference and stores the calculated priority in the priority data storage unit 16 and thus updates the priority (arrow Y6 of FIG. 3, step S4 of FIG. 5). The process of calculating the priority will be described in detail later. The image inspection apparatus 10 also updates the model by learning the model so that the output image from the model becomes the normal image into which the abnormality-simulated data has yet to be inserted, based on the calculated difference (arrow Y7 of FIG. 3, step S5 of FIG. 5).

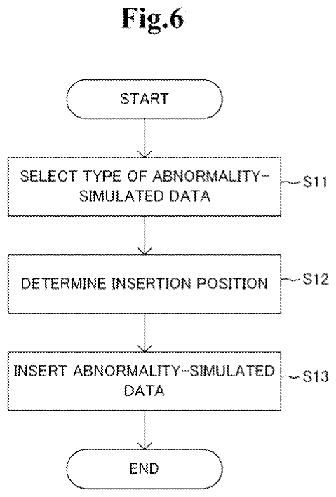

Next, referring to the flowchart of FIG. 6, the operation of generating the abnormal image by inserting the abnormality-simulated data into the normal image, which is step 2 of FIG. 5 described above, will be described. First, the image inspection apparatus 10 reads, from the priority data storage unit 16, the type priorities set for each type of abnormality-simulated data shown in the upper diagram of FIG. 2. Then, assuming that the sum of the type priorities is A and the type priority of each abnormality-simulated data is B, the image inspection apparatus 10 calculates B/A as the probability that each abnormality-simulated data will be selected. The image inspection apparatus 10 then selects the type of abnormality-simulated data to be inserted, using a random number such that each abnormality-simulated data is selected with the probability of B/A (step S11).

The image inspection apparatus 10 then reads, from the priority data storage unit 16, the position priorities set for respective coordinates on the normal image into which abnormality-simulated data may be inserted, shown in the lower diagram of FIG. 2. Then, assuming that the sum of the position priorities is A and the position priority of the respective coordinates is B, the image inspection apparatus 10 calculates B/A as the probability that the respective coordinates will be selected. The image inspection apparatus 10 then selects the coordinates into which the abnormality-simulated data is to be inserted, using a random number such that the respective coordinates are selected with the probability of B/A (step S12).

The image inspection apparatus 10 then generates an abnormal image by inserting the determined type of abnormality-simulated data into the position of the determined coordinates on the normal image (step S13).

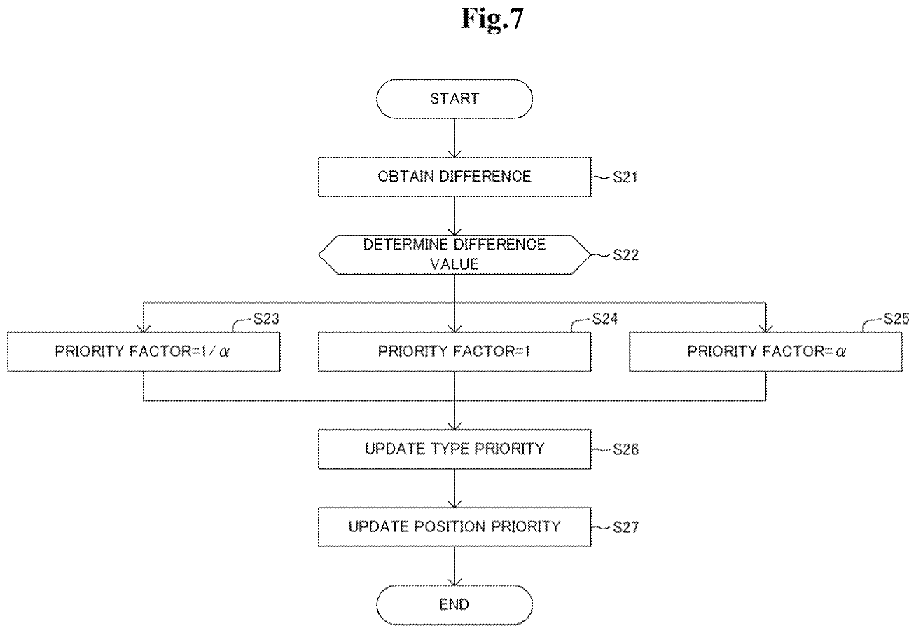

Next, referring to the flowchart of FIG. 7, the operation of updating the priority (type priority, position priority), which is step 4 of FIG. 5 described above, will be described. First, the image inspection apparatus 10 obtains the difference between the output image outputted from the model in the learning and the normal image into the abnormality-simulated data has yet to be inserted (step S21). For example, the image inspection apparatus 10 obtains the pixel-by-pixel difference values between the normal image and the output image and uses the sum of the absolute values of the difference values as the difference.

The image inspection apparatus 10 then determines the relationship among the normal image, the output image, the difference, and thresholds M and N (M<N) (step S22) and sets the priority factor as follows based on the relationship: if difference value<M, priority factor is “1/α” (α>1) (step S23);

if M<difference value<N, priority factor is “1” (step S24); and
if N<difference value, priority factor is “α” (α>1) (step S25).

The image inspection apparatus 10 then calculates a new type priority by multiplying the current type priority of the type of the inserted abnormality-simulated data by the set priority factor and stores the calculated new type priority in the priority data storage unit 16 and thus updates the type priority (step S26). Similarly, the image inspection apparatus 10 calculates a new position priority by multiplying the current position priority of the position into which the abnormality-simulated data has been inserted, by the set priority factor and stores the calculated new position priority in the priority data storage unit 16 and thus updates the position priority (step S27).

Next, the operation during the inspection will be described with reference to the diagram showing the aspect of the process of FIG. 4. First, the image inspection apparatus 10 inputs the captured inspection image of the product to the model consisting of the neural network NN that has undergone the learning (arrow Y11). The image inspection apparatus 10 then acquires the output image outputted from the model (arrow Y12) and calculates the difference between the output image and the inspection image (arrow Y13). The image inspection apparatus 10 then determines whether the inspection image is normal or abnormal, based on the difference (arrow 14). For example, if the difference value is equal to or greater than the preset determination threshold, the image inspection apparatus 10 determines that the inspection image is abnormal; if the difference value is smaller than the threshold, it determines that the inspection image is normal.

As seen above, in the present invention, the priority of the abnormality-simulated data is newly set based on the difference between the normal image and the output image from the model that has learned to eliminate the abnormality-simulated data from the abnormal image obtained by inserting the abnormality-simulated data into the normal image. In particular, the priority is newly set such that the priority is larger as the difference between the output image and normal image is larger. Thus, the priority of type or insertion position of abnormality-simulated data that is difficult to eliminate is set to a greater value, and such a type or insertion position is allowed to be learned more frequently, that is, to be learned sufficiently, resulting in an improvement in the abnormal product detection accuracy.

### Second Example Embodiment

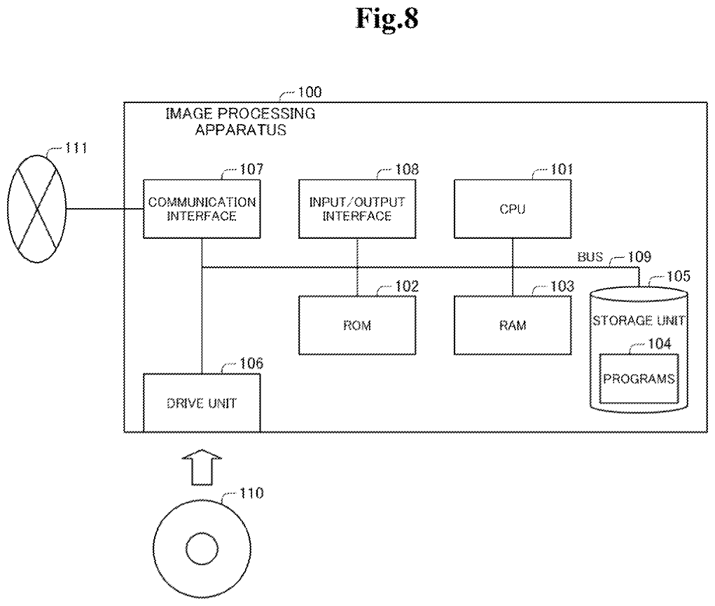

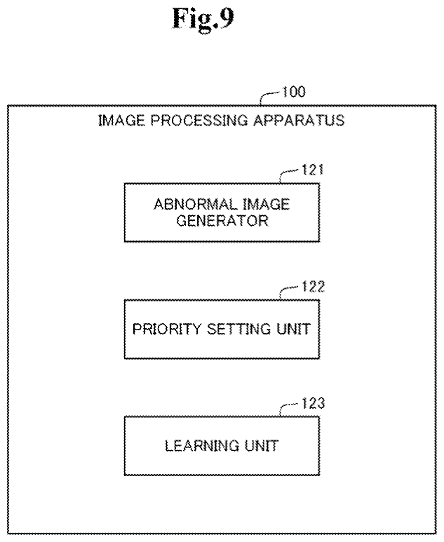

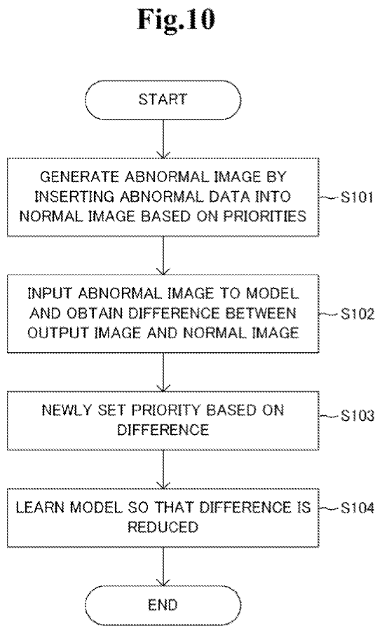

Next, a second example embodiment of the present invention will be described with reference to FIGS. 8 to 10. FIGS. 8 and 9 are block diagrams showing the configuration of an image processing apparatus according to the second example embodiment, and FIG. 10 is a flowchart showing an operation of the image processing apparatus. In the present example embodiment, the configurations of the image inspection apparatus and the method performed by the image inspection apparatus described in the first example embodiment will be outlined.

First, the hardware configuration of an image processing apparatus 100 according to the present example embodiment will be described with reference to FIG. 8. The image processing apparatus 100 consists of a typical information processing apparatus and includes, for example, the following hardware components:

a CPU (central processing unit) 101 (arithmetic logic unit);
ROM (read-only memory) 102 (storage unit);
RAM (random access memory) 103 (storage unit);
programs 104 loaded into the RAM 103;
a storage unit 105 storing the programs 104;
a drive unit 106 that writes and reads to and from a storage medium 110 outside the information processing apparatus;
a communication interface 107 that connects with a communication network 111 outside the information processing apparatus;
an input/output interface 108 through which data is outputted and inputted; and
a bus 109 through which the components are connected to each other.

When the CPU 101 acquires and executes the programs 104, an abnormal image generator 121, a priority setting unit 122, and a learning unit 123 shown in FIG. 9 are implemented in the image processing apparatus 100. The programs 104 are previously stored in, for example, the storage unit 105 or ROM 102, and the CPU 101 loads and executes them into the RAM 103 when necessary. The programs 104 may be provided to the CPU 101 through the communication network 111. The programs 104 may also be previously stored in the storage medium 110, and the drive unit 106 may read the programs and provide them to the CPU 101. Note that the abnormal image generator 121, priority setting unit 122, and learning unit 123 may be implemented by an electronic circuit.

The hardware configuration of the information processing apparatus serving as the image processing apparatus 100 shown in FIG. 8 is only illustrative and not limiting. For example, the information processing apparatus does not have to include one or some of the above components, such as the drive unit 106.

The image processing apparatus 100 performs an image processing method shown in the flowchart of FIG. 10 using the functions of the abnormal image generator 121, priority setting unit 122, and learning unit 123 implemented based on the programs.

As shown in FIG. 10, the image processing apparatus 100:

generates an abnormal image by inserting abnormal data into a learning normal image based on priories set for each abnormal data (step S101);
inputs the abnormal image to a model that has learned to eliminate the abnormal data from the abnormal image and obtains the difference between an output image outputted from the model and the learning normal image (step S102); newly sets the priority of the abnormal data inserted into the learning normal image based on the difference (step S103); and
learns the model so that the difference between the output image and learning normal image is reduced (step S104).

According to the present invention thus configured, the priority of the abnormality-simulated data is newly set based on the difference between the learning normal image and the output image from the model that has learned to eliminate the abnormal data from the abnormal image obtained by inserting the abnormal data into the learning normal image. That is, the priority of the abnormal data is newly set based on the state of elimination. This allows for, for example, sufficiently learning abnormal data that is difficult to eliminate and thus increasing the abnormal product detection accuracy.

The above programs can be stored in various types of non-transitory computer-readable media and provided therefrom to a computer. The non-transitory computer-readable media include various types of tangible storage media. The non-transitory computer-readable media include, for example, a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, a semiconductor memory (for example, a mask ROM, a PROM (Programmable ROM), an EPROM (Erasable PROM), a flash ROM, a RAM (Random Access Memory)). The programs may be provided to a computer by using various types of transitory computer-readable media. The transitory computer-readable media include, for example, an electric signal, an optical signal, and an electromagnetic wave. The transitory computer-readable media can provide the programs to a computer via a wired communication channel such as an electric wire and an optical fiber or via a wireless communication channel.

While the present invention has been described with reference to the example embodiments and so on, the present invention is not limited to the example embodiments described above. The configurations and details of the present invention can be changed in various manners that can be understood by one skilled in the art within the scope of the present invention.

The present invention is based upon and claims the benefit of priority from Japanese Patent Application No. 2019-042432 filed on Mar. 8, 2019 in Japan, the disclosure of which is incorporated herein in its entirety by reference.

### <Supplementary Notes>

Some or all of the example embodiments disclosed above can be described as the following supplementary notes. The overview of the configurations of the information processing apparatus, the information processing method and the program according to the present invention will be described below. However, the present invention is not limited to the following configurations.

### (Supplementary Note 1)

An image processing method comprising:

generating an abnormal image by inserting abnormal data into a learning normal image based on priorities set for each abnormal data;

inputting the abnormal image to a model that has learned to eliminate the abnormal data from the abnormal image and newly setting the priority of the abnormal data inserted into the learning normal image based on a difference between an output image outputted from the model and the learning normal image; and learning the model so that the difference between the output image and the learning normal image is reduced.

### (Supplementary Note 2)

The image processing method according to Supplementary Note 1, wherein

the abnormal image is generated by more preferentially inserting the abnormal data as the priority of the abnormal data has a larger value, and

the priority of the abnormal data inserted into the learning normal image is newly set such that the priority has a larger value as the difference between the output image and the learning normal image is larger.

### (Supplementary Note 3)

The image processing method according to Supplementary Note 2, wherein

the priority of the abnormal data inserted into the learning normal image is newly set by setting a priority factor having a larger value as the difference between the output image and the learning normal image is larger and multiplying the priority by the priority factor.

### (Supplementary Note 4)

The image processing method any one of Supplementary Notes 1 to 3, wherein

the generating comprises generating the abnormal image by inserting the abnormal data into a predetermined position on the learning normal image based on position priorities set for each position on the learning normal image, and

the position priorities set for each position on the learning normal image are newly set based on the difference between the output image and the learning normal image.

### (Supplementary Note 5)

The image processing method according to Supplementary Note 4, wherein

the generating comprises generating the abnormal image by inserting the abnormal data more preferentially into a position on the learning normal image as the position priority of the position has a larger value, and

the position priority set for the position on the learning normal image into which the abnormal data has been inserted is newly set such that the position priority has a larger value as the difference between the output image and the learning normal image is larger.

### (Supplementary Note 6)

The image processing method according to Supplementary Note 5, wherein

the position priority set for the position on the learning normal image into which the abnormal data has been inserted is newly set by setting a priority factor having a larger value as the difference between the output image and the learning normal image is larger and multiplying the position priority by the priority factor.

### (Supplementary Note 7)

The image processing method according to Supplementary Note 5 or 6, wherein the position priorities set for the position on the learning normal image into which the abnormal data has been inserted and positions in a predetermined range around the position are newly set such that the position priorities have larger values as the difference between the output image and the learning normal image is larger.

### (Supplementary Note 7.1)

The image processing method according to any of Supplementary Notes 1 to 7, wherein a sum of differences between predetermined values of all mutually corresponding pixels of the output image and the learning normal image is obtained as the difference.

### (Supplementary Note 8)

The image processing method according to any of Supplementary Notes 1 to 7, wherein

an inspection image is inputted to the learned model and it is determined whether the inspection image is normal or abnormal, based on a difference between an inspection output image outputted from the model and the inspection image.

### (Supplementary Note 9)

An image processing apparatus comprising:

an abnormal image generator configured to generate an abnormal image by inserting abnormal data into a learning normal image based on priorities set for each abnormal data;

a priority setting unit configured to input the abnormal image to a model that has learned to eliminate the abnormal data from the abnormal image and to newly set the priority of the abnormal data inserted into the learning normal image based on a difference between an output image outputted from the model and the learning normal image; and

a learning unit configured to learn the model so that the difference between the output image and the learning normal image is reduced.

### (Supplementary Note 9.1)

The image processing apparatus according to Supplementary Note 9, wherein the abnormal image generator generates the abnormal image by more preferentially inserting the abnormal data as the priority of the abnormal data has a larger value, and

the priority setting unit newly sets the priority of the abnormal data inserted into the learning normal image such that the priority has a larger value as the difference between the output image and the learning normal image is larger.

### (Supplementary Note 9.2)

The image processing apparatus according to Supplementary Note 9.1, wherein

the priority setting unit newly sets the priority of the abnormal data inserted into the learning normal image by setting a priority factor having a larger value as the difference between the output image and the learning normal image is larger and multiplying the priority by the priority factor.

### (Supplementary Note 9.3)

The image processing apparatus of any one of Supplementary Note 9 to 9.2, wherein

the abnormal image generator generates the abnormal image by inserting the abnormal data into a predetermined position on the learning normal image based on position priorities set for each position on the learning normal image, and

the priority setting unit inputs the abnormal image to the model and newly sets the position priorities set for each position on the learning normal image based on the difference between the output image and the learning normal image.

### (Supplementary Note 9.4)

The image processing apparatus according to Supplementary Note 9.3, wherein

the abnormal image generator generates the abnormal image by inserting the abnormal data more preferentially into a position on the learning normal image as the position priority of the position has a larger value, and

the priority setting unit newly sets the position priority set for the position on the learning normal image into which the abnormal data has been inserted such that the position priority has a larger value as the difference between the output image and the learning normal image is larger.

### (Supplementary Note 9.5)

The image processing apparatus according to Supplementary Note 9.4, wherein

the priority setting unit newly sets the position priority set for the position on the learning normal image into which the abnormal data has been inserted by setting a priority factor having a larger value as the difference between the output image and the learning normal image is larger and multiplying the position priority by the priority factor.

### (Supplementary Note 9.6)

The image processing apparatus according to Supplementary Note 9.4 or 9.5, wherein

the priority setting unit newly sets the position priorities set for the position on the learning normal image into which the abnormal data has been inserted and positions in a predetermined range around the position such that the position priorities have larger values as the difference between the output image and the learning normal image is larger.

### (Supplementary Note 9.7)

The image processing apparatus according to any of Supplementary Notes 9 to 9.6, further comprising a determination unit configured to input an inspection image to the learned model and to determine whether the inspection image is normal or abnormal, based on a difference between an inspection output image outputted from the model and the inspection image.

### (Supplementary Note 10)

A non-transitory computer-readable storage medium storing a program for implementing, in an information processing apparatus:

an abnormal image generator configured to generate an abnormal image by inserting abnormal data into a learning normal image based on priorities set for each abnormal data;

a priority setting unit configured to input the abnormal image to a model that has learned to eliminate the abnormal data from the abnormal image and to newly set the priority of the abnormal data inserted into the learning normal image based on a difference between an output image outputted from the model and the learning normal image; and

a learning unit configured to learn the model so that the difference between the output image and the learning normal image is reduced.

### DESCRIPTION OF NUMERALS

10 image inspection apparatus
11 abnormal image generator
12 abnormality eliminator
13 priority setting unit
14 determination unit
16 priority data storage unit
17 model storage unit
100 image processing apparatus
101 CPU
102 ROM
103 RAM
104 programs
105 storage unit
106 drive unit
107 communication interface
108 input/output interface
109 bus
110 storage medium
111 communication network
121 abnormal image generator
122 priority setting unit
123 leaning unit

What is claimed is:

1. An image processing method comprising:
generating an abnormal image by inserting abnormal data into a learning normal image based on priorities set for each abnormal data;
inputting the abnormal image to a model that has learned to eliminate the abnormal data from the abnormal image and newly setting the priority of the abnormal data inserted into the learning normal image based on a difference between an output image outputted from the model and the learning normal image; and
learning the model so that the difference between the output image and the learning normal image is reduced.

2. The image processing method according to claim 1, wherein
the abnormal image is generated by more preferentially inserting the abnormal data as the priority of the abnormal data has a larger value, and
the priority of the abnormal data inserted into the learning normal image is newly set such that the priority has a larger value as the difference between the output image and the learning normal image is larger.

3. The image processing method according to claim 2, wherein
the priority of the abnormal data inserted into the learning normal image is newly set by setting a priority factor having a larger value as the difference between the output image and the learning normal image is larger and multiplying the priority by the priority factor.

4. The image processing method according to claim 1, wherein
the abnormal image is generated by inserting the abnormal data into a predetermined position on the learning normal image based on position priorities set for each position on the learning normal image, and
the position priorities set for each position on the learning normal image are newly set based on the difference between the output image and the learning normal image.

5. The image processing method according to claim 4, wherein
the abnormal image is generated by inserting the abnormal data more preferentially into a position on the learning normal image as the position priority of the position has a larger value, and
the position priority set for the position on the learning normal image into which the abnormal data has been inserted is newly set such that the position priority has a larger value as the difference between the output image and the learning normal image is larger.

6. The image processing method according to claim 5, wherein
the position priority set for the position on the learning normal image into which the abnormal data has been inserted is newly set by setting a priority factor having a larger value as the difference between the output image and the learning normal image is larger and multiplying the position priority by the priority factor.

7. The image processing method according to claim 5, wherein
the position priorities set for the position on the learning normal image into which the abnormal data has been inserted and positions in a predetermined range around the position are newly set such that the position priorities have larger values as the difference between the output image and the learning normal image is larger.

8. The image processing method according to claim 1, wherein a sum of differences between predetermined values of all mutually corresponding pixels of the output image and the learning normal image is obtained as the difference.

9. The image processing method according to claim 1, wherein
an inspection image is inputted to the learned model and it is determined whether the inspection image is normal or abnormal, based on a difference between an inspection output image outputted from the model and the inspection image.

10. An image processing apparatus comprising:
a memory storing processing instructions; and
at least one processor configured to execute the processing instructions, the processing instructions comprising:
generating an abnormal image by inserting abnormal data into a learning normal image based on priorities set for each abnormal data;
inputting the abnormal image to a model, the model having learned to eliminate the abnormal data from the abnormal image, and to newly set the priority of the abnormal data inserted into the learning normal image based on a difference between an output image outputted from the model and the learning normal image; and
learning the model so that the difference between the output image and the learning normal image is reduced.

11. The image processing apparatus according to claim 10, wherein
the processing instructions comprise:
generating the abnormal image by more preferentially inserting the abnormal data as the priority of the abnormal data has a larger value; and
newly setting the priority of the abnormal data inserted into the learning normal image such that the priority has a larger value as the difference between the output image and the learning normal image is larger.

12. The image processing apparatus according to claim 11, wherein
the processing instructions comprise newly setting the priority of the abnormal data inserted into the learning normal image by setting a priority factor having a larger value as the difference between the output image and the learning normal image is larger and multiplying the priority by the priority factor.

13. The image processing apparatus according to claim 10, wherein
the processing instructions comprise:
generating the abnormal image by inserting the abnormal data into a predetermined position on the learning normal image based on position priorities set for each position on the learning normal image; and
inputting the abnormal image to the model and to newly set the position priorities set for each position on the learning normal image based on the difference between the output image and the learning normal image.

14. The image processing apparatus according to claim 13, wherein
the processing instructions comprise:
generating the abnormal image by inserting the abnormal data more preferentially into a position on the learning normal image as the position priority of the position has a larger value; and
newly setting the position priority set for the position on the learning normal image into which the abnormal data has been inserted such that the position priority has a larger value as the difference between the output image and the learning normal image is larger.

15. The image processing apparatus according to claim 14, wherein
the processing instructions comprise newly setting the position priority set for the position on the learning normal image into which the abnormal data has been inserted by setting a priority factor having a larger value as the difference between the output image and the learning normal image is larger and multiplying the position priority by the priority factor.

16. The image processing apparatus according to claim 14, wherein
the processing instructions comprise newly setting the position priorities set for the position on the learning normal image into which the abnormal data has been inserted and positions in a predetermined range around the position such that the position priorities have larger values as the difference between the output image and the learning normal image is larger.

17. The image processing apparatus according to claim 10, wherein
the processing instructions comprise inputting an inspection image to the learned model and to determine whether the inspection image is normal or abnormal, based on a difference between an inspection output image outputted from the model and the inspection image.

18. A non-transitory computer-readable storage medium storing a program for causing an information processing apparatus to perform:
an operation of generating an abnormal image by inserting abnormal data into a learning normal image based on priorities set for each abnormal data;
an operation of inputting the abnormal image to a model that has learned to eliminate the abnormal data from the abnormal image and to newly set the priority of the abnormal data inserted into the learning normal image based on a difference between an output image outputted from the model and the learning normal image; and
an operation of learning the model so that the difference between the output image and the learning normal image is reduced.
